(19) United States
(12) Patent Application Publication
(10) Pub. No.: US 2007/0271560 A1
(43) Pub. Date: Nov. 22, 2007

(54) Deploying virtual machine to host based on workload characterizations

(75) Inventors: Brian M. Wahlert, Bellevue, WA (US); Rene Antonio Vega, Kirkland, WA (US); Robert Gibson, Monroe, WA (US); Robert M. Fries, Kirkland, WA (US); William L. Scheidel, Sammamish, WA (US); Pavel A. Dournov, Redmond, WA (US); John Morgan Oslake, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/437,142

(22) Filed: May 18, 2006

(51) Int. Cl. G06F 9/455

(52) U.S. Cl. 718/1

(57) ABSTRACT

To determine whether to deploy a candidate VM to a candidate host, taking into consideration resources available from the candidate host and resources required by the candidate VM, a sub-rating is calculated for each of several resources available from the candidate host, where the sub-rating for the resource corresponds to an amount of the resource that is free after the candidate VM is deployed to the candidate host. Thereafter, a rating is calculated from the calculated sub-ratings to characterize how well the candidate host can accommodate the candidate VM. The rating for the candidate host are presented to a selector that determines whether to deploy the candidate VM to the candidate host based on the rating thereof.

### TECHNICAL FIELD

The present invention relates to selecting a host for a virtual machine based on a characterization of the workload of each of a plurality of hosts as well as a characterization of the workload of the virtual machine. In a similar manner, the present invention relates to determining whether a physical machine should or could be virtualized as a virtual machine and deployed to a host, here based on a characterization of the workload of a typical host as well as a characterization of the workload of the physical machine.

### BACKGROUND OF THE INVENTION

As should be appreciated, a virtual machine (‘VM’) is a software construct or the like operating on a computing device or the like (i.e., a ‘host’) for the purpose of emulating a hardware system. Typically, although not necessarily, the VM is an application or the like, and may be employed on the host to instantiate a use application or the like while at the same time isolating such use application from such host device or from other applications on such host. In one typical situation, the host can accommodate a plurality of deployed VMs, each VM performing some predetermined function by way of resources available from the host. Notably, each VM is for all intents and purposes a computing machine, although in virtual form, and thus represents itself as such both to the use application thereof and to the outside world.

Typically, although not necessarily, a host deploys each VM thereof in a separate partition. Such host may include a virtualization layer with a VM monitor or the like that acts as an overseer application or ‘hypervisor’, where the virtualization layer oversees and/or otherwise manages supervisory aspects of each VM of the host, and acts as a possible link between each VM and the outside world.

One hallmark of a VM is that the VM as a virtual construct can be halted and re-started at will, and also that the VM upon being halted can be stored and retrieved in the manner of a file or the like. In particular, the VM as instantiated on a particular computing device is a singular software construct that can be neatly packaged inasmuch as the software construct includes all data relating to such VM, including operating data and state information relating to the VM. As a result, a VM on a first host can be moved or ‘migrated’ to a second host by halting the VM at the first host, moving the halted VM to the second host, and re-starting the moved VM at the second host, or the like. More generally, a VM can be migrated from a first platform to a second platform in a similar manner, where the platforms represent different hosts, different configurations of the same host, or the like. In the latter case, and as should be appreciated, a computing device may have a different configuration if, for example, additional memory is added, a processor is changed, an additional input device is provided, a selection device is removed, etc.

Virtualization by way of VMs may be employed to allow a relatively powerful computer system to act as a host for a collection of independent, isolated VMs. As such, the VMs on a host co-exist on the same hardware platform and operate as though each VM has exclusive access to the resources available from and by way of the host. Accordingly, virtualization allows optimum usage of each host, and also allows migration of VMs among a set of hosts/platforms based on demand, needs, requirements, capacity, availability, and other typical constraints.

Virtualization also allows a user with physical machines each operating an application to consolidate such applications to a set of hosts, thereby reducing overall hardware needs. Thus, and as but one example, a user with multiple physical machines each acting as a server or the like may find that each physical server may be virtualized to a VM, and that multiple such VMs may reside on a single host. Although widely varying, it is not unheard of that with such VMs a single host can accommodate the equivalent of five or ten or more physical machines. To summarize, then, virtualization results in a user being able to take fuller advantage of existing hardware by utilizing such hardware at a much higher rate. In fact, inasmuch as a typical user may only utilize about 15 percent of available hardware resources on average when deploying physical servers, virtualization can be employed to provide three-, four-, and perhaps even five- and six-fold increases in such utilization, allowing of course for reserve capacity and overhead associated with accommodating VMs.

More specifically, a typical user has many server machines and the like that run varied workloads which do not fully utilize the underlying hardware. Furthermore, some of the hardware is nearing end of life and it may be difficult to justify upgrading the hardware to a more modern, faster system when the existing hardware is not fully utilized. The user thus would benefit from employing virtualization to enable a solution that consolidates the server machines and the like as VMs to a set of hosts. However, and significantly, such a user requires a management tool that can guide such user in selecting which server machines and the like to virtualize, and also in selecting which host is to accommodate each VM.

In other words, the user requires a management tool that can guide such a user in placing the server machines or the like as VMs on the set of hosts. Generally, deployment deals with efficiently matching a defined workload to a set of compatible physical resources to service the workload. If deployment is inefficient or allows for incompatible matches of resources to requirements, the goal of optimizing hardware usage becomes difficult if not impossible to achieve. Thus, the present invention facilitates compatible, efficient deployment and takes into account resource requirements including networking, storage, licensing, compute power, memory, and the like.

### SUMMARY OF THE INVENTION

In the present invention, a system and method are provided with regard to a candidate virtual machine (VM) and a candidate host computing device (host) upon which the candidate VM is potentially to be deployed. Such system and method are for assisting in determining whether to deploy the candidate VM to the candidate host, taking into consideration resources available from the candidate host and resources required by the candidate VM.

A sub-rating is calculated for each of several resources available from the candidate host, where the sub-rating for the resource corresponds to an amount of the resource that is free after the candidate VM is deployed to the candidate host. Thereafter, a rating is calculated from the calculated sub-ratings to characterize how well the candidate host can accommodate the candidate VM. The rating for each candidate host is presented to a selector that determines whether to deploy the candidate VM to the candidate host based on the rating thereof. A selection of the candidate host is received for deployment of the candidate VM thereon, and the resources of the selected host as required by the candidate VM are reserved until the candidate VM is deployed to the selected host. Thereafter, the candidate VM is deployed to the selected host.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a block diagram representing a general purpose computer system in which aspects of the present invention and/or portions thereof may be incorporated;

FIG. 2 is a block diagram showing a system of physical machines or the like that are or can be virtualized as virtual machines (VMs), each of which is to be deployed to potentially any of a set of hosts 14 in embodiments of the present invention;

FIG. 3 is a block diagram showing a system for evaluating one or more VMs of FIG. 2 to be deployed to one or more hosts in accordance with embodiments of the present invention;

FIG. 4 is a flow diagram showing key steps performed in connection with the system of FIG. 3 to evaluate one or more VMs to be deployed to one or more hosts in accordance with embodiments of the present invention;

FIG. 5 is a block diagram showing a representation of a resource of a host of FIG. 2 as employed by a VM, and in particular how a sub-rating of FIG. 4 corresponds to the percent utilization of the resource remaining free after a VM 12 deployed to the host; and

FIG. 6 is a flow diagram showing key steps performed in aggregating sample data to produce utilization data with regard to a resource such as may be employed in connection with the system of FIG. 3 in accordance with embodiments of the present invention.

### DETAILED DESCRIPTION OF THE INVENTION

### Computer Environment

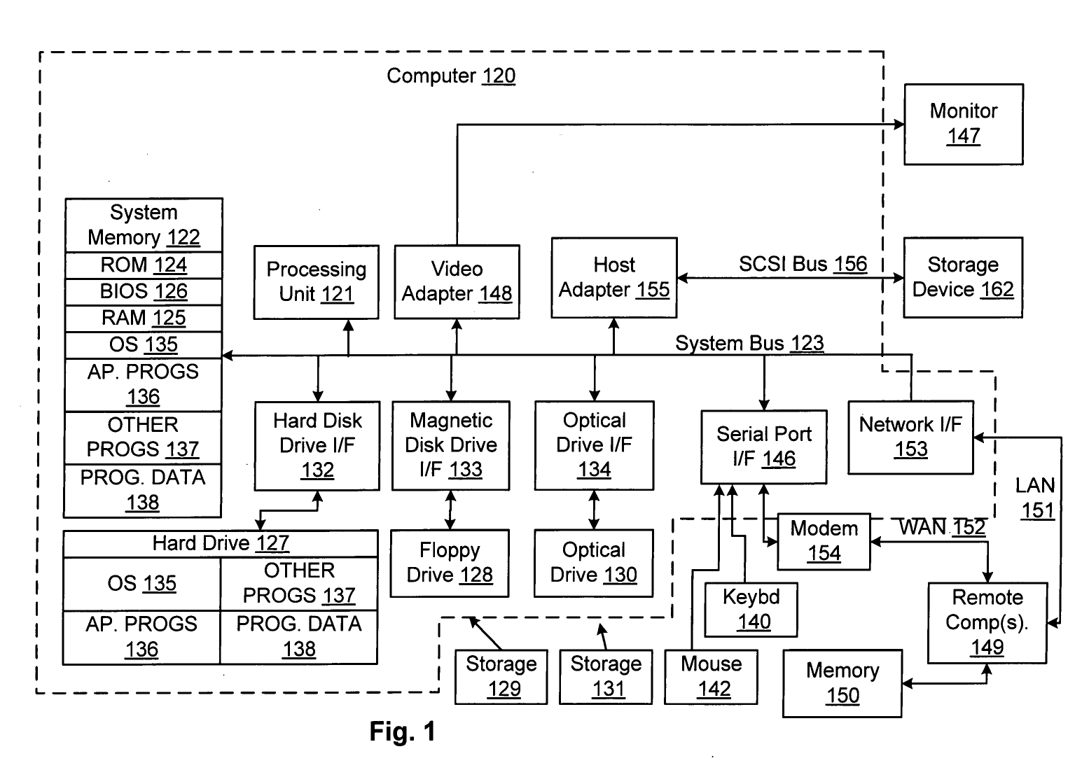

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional computing device 120 such as a personal computer, a server, or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

### Hosts and Virtual Machines

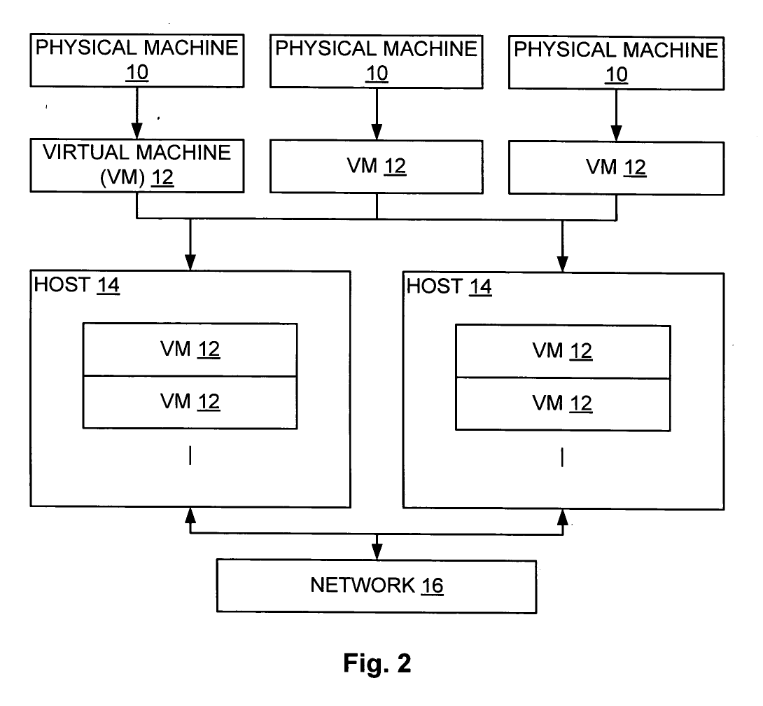

Turning now to FIG. 2, it seen that the present invention may have particular applicability in the context of physical machines 10 or the like that are or can be virtualized as virtual machines (VMs) 12, each of which is to be deployed to potentially any of a set of hosts 14 in an appropriate manner. Note here that the physical machines 10 or the like, VMs 12, and host 14 may be any appropriate server machines or the like, VMs, and host without departing from the spirit and scope of the present invention. Such server machines or the like, VMs, and host are known or should be apparent to the relevant public and therefore need not be set forth herein in any detail beyond that which is already provided.

As was set forth above, each VM 12 is a software construct or the like that when deployed to a host 14 emulates the corresponding physical machine 10 or the like. Thus, the VM 12 may employ the resources of the host 14 to instantiate a server or other use application or the like while at the same time isolating such use application from such host 14 and other applications on such host 14. As shown, the host 14 may accommodate a plurality of deployed VMs 12, where each VM 12 independently performs some predetermined function. For example, at least some of the VMs 12 deployed to the host 14 may act as data servers, at least some of such VMs 12 may act as network servers with regard to a network 16 coupled to the host 14, at least some of such VMs 12 may act as mail servers, and at least some of such VMs 12 may perform low-level functions including maintenance functions, data collection, hardware monitoring, error correction, file management, and the like. Notably, each VM 12 is for all intents and purposes a computing machine, although in virtual form.

The host 14 itself may be an appropriate computing device such as a desktop computer, a laptop computer, a handheld computer, a data assistant, a mainframe computer, or any other type of computing device with the functionality and capacity necessary to host one or more of the VMs 12. Bearing in mind that each VM may require significant memory, I/O operations, storage capacity, and processor capacity from the host 14, however, and also bearing in mind that the host 14 may be expected to accommodate 2, 5, 10, 20 or more of the VMs 12 at any one time, the host 14 likely should have significant power and resources to be able to in fact accommodate such VMs 12.

With regard to each physical machine 10 or the like, it is to be appreciated that each VM 12 most typically corresponds to such a physical machine 10 such as a server, but could in fact correspond to any type of physical computing device without departing from the spirit and scope of the present invention. Thus, in addition to the server as the physical machine 10, each VM 12 could correspond to any other type of application-type physical machine, including but not limited to any maintenance machine, data collection machine, hardware monitoring machine, error correction machine, file management machine, and the like. Moreover, each VM 12 could also correspond to any sub-machine level application, including a word processor, a spreadsheet analyzer, a mail application, a database application, a drawing application, a content rendering application, and the like.

### Evaluating Virtual Machine Deployment

A user in deciding whether to virtualize a physical machine 10 or the like generally (1) determines whether the physical machine 10 is an acceptable candidate for virtualization, and (2) for a good candidate, converts the physical machine 10 into a virtual machine (VM) 12. Converting the physical machine 10 into a VM 12 may be performed in any appropriate manner without departing from the spirit and scope of the present invention. Inasmuch as converting the physical machine 10 into a VM 12 is generally known or should be apparent to the relevant public, details for doing so need not be set forth herein in any detail except that which is provided.

At any rate, once a VM 12 corresponding to the physical machine 10 has been produced, (3) one or more candidate host 14 are identified as hosts 14 on which the VM can be deployed in an efficient and/or otherwise acceptable manner, and (4) such VM 12 may then be deployed to a selected one of the candidate hosts 14. Notably, the present invention may be employed to assist in the decision-making performed at steps (1) and (3). That is, the present invention provides a system by which it can be determined whether a physical machine 10 should or could be virtualized as a VM 12 and deployed to a host 14, based on a characterization of the workload of a typical host 14 as well as a characterization of the workload of the physical machine 10. In addition, the same tool can be employed to determine whether one or more candidate hosts 14 is acceptable for a VM 12, again based on a characterization of the workload of each candidate host 14 as well as a characterization of the VM 12.

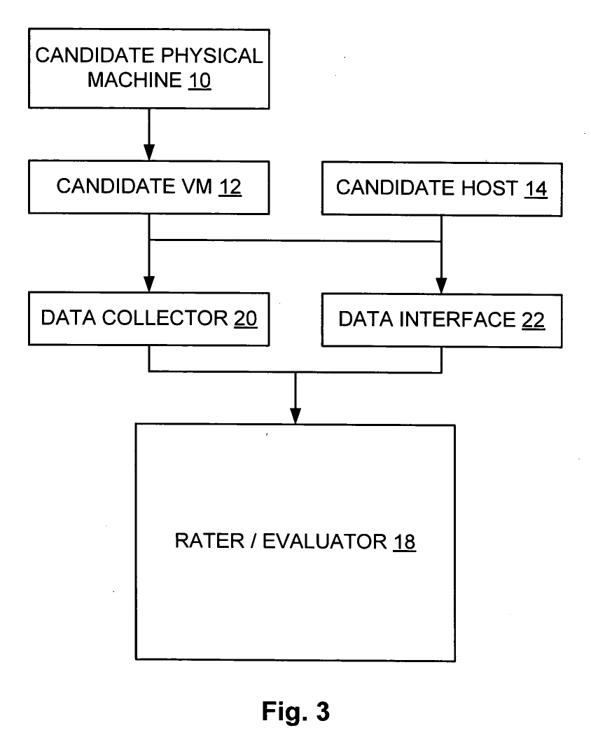

Turning now to FIG. 3, a system for performing the present invention is shown. In such system, and as seen, an evaluator 18 receives data relating to a model of a candidate VM 12 and at least one candidate host 14 to determine whether each candidate host 14 has the capacity to accommodate the candidate VM 12 as deployed thereon. Note here that in the context of determining whether a physical machine 10 should or could be virtualized as a VM 12 and deployed to a host 14, the candidate VM 12 is a characterization of the physical machine 10 as virtualized, while a single candidate host 14 is a composite host 14 meant to characterize a host 14 upon which the VM 12 would be deployed. Note that such characterized host 14 may be an average host, a best available host, a high average host, or the like as circumstances dictate. In the context of determining whether one or more candidate hosts 14 is acceptable for a VM 12, the candidate VM 12 is a VM 12 that is to be deployed to any of a plurality of candidate hosts 14.

In either instance, the evaluator 18 receives for the candidate VM 12 model data including a reference processor configuration for the candidate VM 12, and a determined workload characterization for the candidate VM 12. Such reference processor configuration may for example be that the candidate VM 12 has a particular processor operating at a particular speed with particular resources available. The candidate VM 12 typically has associated model data that specifies the capacity required for running the workload of such VM 12 in the context of the reference processor configuration, and for example can specify the processor utilization that the VM 12 would incur on a specific reference processor.

Such workload characterization may be based on various factors, and as such may include a characterization of workload with regard to utilization of different resources of the candidate VM 12, such as the processor (percentage utilized, e.g.), the memory (amount available, reads and writes per unit of time, etc.), the storage capacity (amount available, reads and writes per unit of time, etc.), the network 16 (bandwidth available, reads and writes per unit time, etc.), and the like. Of course, such workload characterization may be based on other factors without departing from the spirit and scope of the present invention, including non-utilization factors such as software versions, included hardware, and the like.

Also, workload characterization may be specified in different terms without departing from the spirit and scope of the present invention. In that regard, note that workload may be specified in different units for different resources. For example, processor load may be specified as a percentage utilization while network load may be specified in terms of network traffic in bytes/sec. Note also that storage load may include a storage throughput specification including a number of bytes and I/O operations that are performed by the VM 12 per unit of time. Note too that network load may not necessarily be specified as bandwidth because network traffic may not depend on same. Note finally that workload may be specified in terms of physical resources. At any rate, however workload is characterized, the evaluator 18 appropriately converts such characterized workload into a form amenable to the calculations set forth below. Such conversions are known or should be apparent to the relevant public and therefore need not be set forth herein in any detail other than that which is provided.

As may be appreciated, processor configuration and workload characterization with regard to the candidate VM 12 is in fact a virtual configuration and characterization, inasmuch as the candidate VM 12 is a virtual device. Nevertheless, such virtual configuration and workload characterization are applicable to determining the resources required from each candidate host 14, at least with regard to the factors of the workload characterization. Generally, in the present invention, the evaluator 18 takes as input a representation of a workload, be it a candidate VM 12 or a candidate physical machine 10. In either instance, the workload is described to the evaluator 18 according to data obtained by a data collector 20, a data interface 22, or the like as is seen in FIG. 3. Note with regard to FIG. 3 that such data need not necessarily be derived from a candidate VM 12 derived from a candidate physical machine 10 but could instead be derived directly from the candidate physical machine 10.

In a similar manner, the evaluator 18 also receives for each candidate host 14 model data including an actual processor configuration for the candidate host 14, and an actual workload characterization for each candidate host 14. Similar to before, such actual processor configuration may for example be that the candidate host 14 has a particular processor operating at a particular speed with particular resources available prior to deployment of the candidate VM 12 to such candidate host 14. Here, the actual workload characterization is based on the same factors as the workload characterization of the candidate VM 12, and as such may include a characterization of actual workload with regard to utilization of different resources of the candidate host 14, such as the processor, the memory, the storage capacity, the network 16, and the like.

Note with regard to each candidate host 14 and the candidate VM 12 that at least some of the data for the factors of the workload characterization may be obtained on a historical basis by way of a data collector 20 or the like as the candidate host 14 is operating, as the VM 12 is operating, as the physical machine corresponding to the VM 12 is operating, or the like. As may be appreciated, such a historical data collector 20 may operate in any appropriate manner without departing from the spirit and scope of the present invention. One method for collecting such data is set forth below. Such a historical data collector 20 is known or should be apparent to the relevant public and therefore need not be set forth herein in any particular detail.

Note too with regard to each candidate host 14 that at least some of the actual data for the factors of the workload characterization may be obtained as current data from the candidate host 14 by way of a data interface 22 or the like as the candidate host 14 is operating. As may be appreciated, such a data interface 22 may operate in any appropriate manner without departing from the spirit and scope of the present invention. Such an interface 22 is known or should be apparent to the relevant public and therefore need not be set forth herein in any particular detail. Note too that in at least some circumstances a similar data interface 22 may be employed to obtain at least some current data with regard to the candidate VM 12. For example, such interface 22 may collect such current data from the physical machine 10 corresponding to the candidate VM 12, or from the candidate VM 12 if in operation already on some host 14.

Principally, and in one embodiment of the present invention, the evaluator 18 operates to output a rating with regard to each candidate host 14 that characterizes whether the candidate VM 12 can be deployed to such candidate host 14 and if so how well the candidate host 14 can accommodate the candidate VM 12. Generally, such a rating reflects based on the configurations and workload characterizations whether the candidate host 14 has the capacity to accommodate the candidate VM 12 as deployed thereon, and if so how much capacity in relative terms. For example, the rating may be output as a number from 0-5, with 0 meaning no capacity, 5 meaning maximum capacity, and intermediate values meaning intermediate relative amounts of capacity.

In one embodiment of the present invention, the evaluator 18 operates based on hard requirements and soft requirements. A hard requirement would be defined as a requirement that must be met for the candidate VM 12 to be deployed to a candidate host 14. For example, if the candidate VM 12 requires 2 gigabytes of storage space on the candidate host 14 and the candidate host 14 only has 1 gigabyte available, the candidate VM 12 should not be deployed to such candidate host 14. Generally, hard requirements are evaluated based on actual data obtained by the data interface 22 from each candidate host 14. Examples of such hard requirements generally follow capacity relating to the workload factors set forth above, and thus may include but are not limited to:
processor capacity—the candidate host 14 must have enough percentage processor availability to satisfy the requirements of the candidate VM 12, and in addition a multiple-processor candidate VM 12 can only run on a candidate host 14 running an appropriate version of virtualization software;
storage capacity—the candidate host 14 must have enough free storage space and related storage resources to store and service the candidate VM 12;
memory capacity—the candidate host 14 must have enough memory to allow the candidate VM 12 to run as deployed; and
network capacity—the candidate host 14 must have enough network bandwidth available to access the network 16 as required by the candidate VM 12.

Note that not all of the above may in fact be hard requirements in all circumstances. For one example, processor capacity need not be a hard requirement if degraded performance from lack of sufficient capacity is considered acceptable. For another example, network capacity likewise need not be a hard requirement if degraded performance from lack of sufficient capacity is considered acceptable.

A soft requirement would be defined as a requirement that should be met to achieve a good or acceptable level of performance from the candidate VM 12 as deployed to any particular candidate host 14. That is, a soft requirement should be met, but if not the candidate VM 12 as deployed will still operate, though with a degraded level of service.

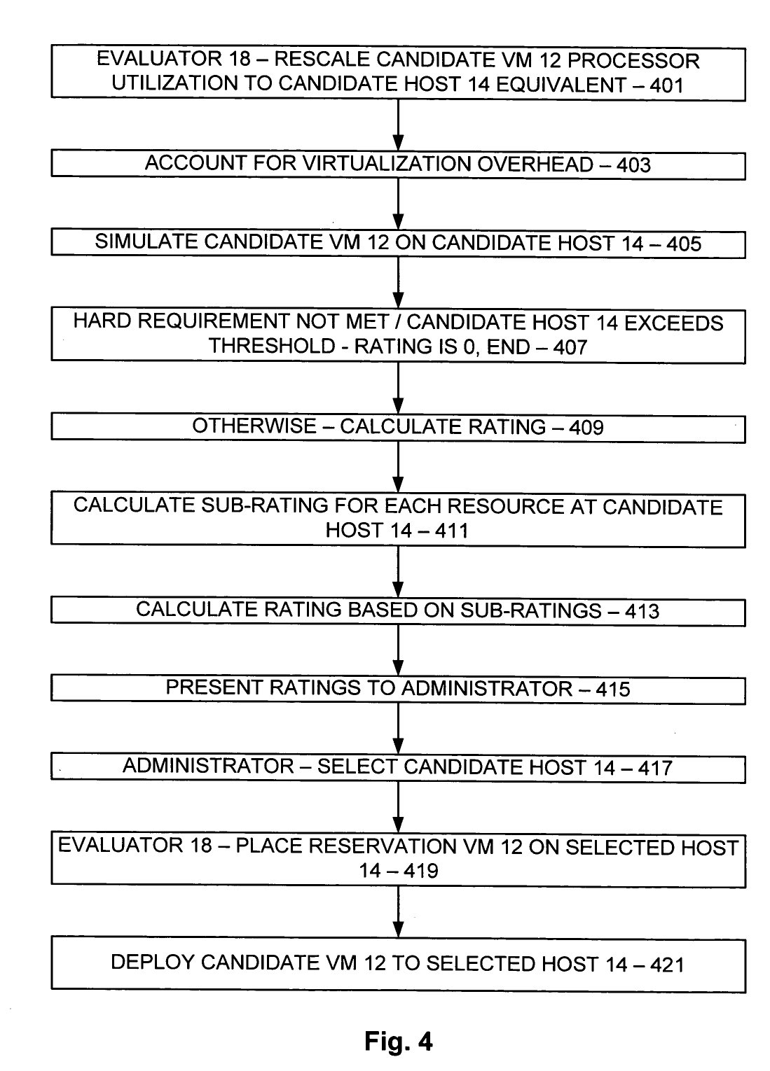

Prior to producing the aforementioned rating for each candidate host 14 with regard to the candidate VM 12, and turning now to FIG. 4, the evaluator in one embodiment of the present invention performs functions including:
resealing the processor utilization of the candidate VM 12 to the equivalent processor utilization of the processor of the candidate host 14 (step 401). For example, if the candidate VM 12 requires 20% of the processor thereof but the processor of the candidate host 14 is found to be faster, it may be the case that the candidate VM 12 would instead require only 8% of such processor of such candidate host 14. As should be appreciated, then, resealing is necessary to compare in equivalent units the processor utilization required by the candidate VM 12 with the processor utilization available from the candidate host 14. As may be appreciated, such resealing may be performed by the evaluator 18 in any appropriate manner without departing from the spirit and scope of the present invention. For example, reference may be made to equivalent rankings of the processor of the candidate VM 12 and the processor of the candidate host 14. The performance ranking of a processor may not be part of model data received by the evaluator 18 from the data collector 20. Instead, the evaluator 18 may maintain a library of processor configurations which include performance rankings. If the library does not contain the processor under evaluation, then the ranking for such processor may be approximated using an algorithm which considers the rankings of similar processor configurations in the library.
accounting for virtualization overhead (step 403). In particular, when a physical machine 10 is virtualized to a VM 12, it is to be appreciated that a host 14 in accommodating the VM 12 must have capacity not only for the VM 12 but for the extra work or ‘overhead’ associated with virtualizing such VM 12. Such overhead is incumbent in any VM 12 and results from device emulation, resource partitioning, and other resources that must be expended to effectuate virtualizing the VM 12. As may be appreciated, the amount of overhead varies depending on the type of workload that can be associated with the candidate VM 12. For example, if the candidate VM 12 requires access to the network 16, overhead must be expended to translate virtual network requests to actual requests. Similarly, if the candidate VM 12 requires access to storage, overhead must be expended to translate disk requests to actual requests. At any rate, overhead may be characterized by the evaluator 18 based on appropriate factors, such as the type of work the candidate VM 12 is to perform, the number of disk requests expected, the number of network requests expected, the number of graphics requests expected, the number of memory accesses, the number of processor exceptions, the number of running processes, and the like. As may be appreciated, then, accounting for overhead may be performed by the evaluator 18 in any appropriate manner without departing from the spirit and scope of the present invention.
simulating running of the candidate VM 12 on the candidate host 14 after scaling and accounting for overhead (step 405). In particular, the evaluator 18 places a ‘dummy’ VM 12 on the candidate host 14 with utilization parameters that at least roughly correspond to the candidate VM 12 as deployed and operating on the candidate host 14 to determine if the candidate host 14 acceptably accommodates such dummy VM 12. Such simulation with such dummy VM 12 is performed in an attempt to confirm that the candidate host 14 can indeed accommodate the candidate VM 12, at least as represented by the dummy VM 12. In essence, placing the dummy VM 12 on the candidate host 14 combines the resource requirements of the candidate VM 12 by way of the dummy VM 12 with the current resource utilization on the candidate host 14 to result in the resource utilization that would result from placing the candidate VM 12 on the candidate host 14.

Note that the dummy VM 12 as placed on the candidate host 14 may actually be deployed or may alternately be conceptually deployed. Particularly with regard to the latter case, actually placing/deploying a dummy VM 12 may not be acceptable inasmuch as such dummy VM 12 would employ actual resources at the candidate host 14, and as such could possibly affect other VMs 12 or the like at such candidate host 14 that are performing actual work. Instead, conceptual deployment by way of computation may be performed, and in so doing the performance requirements of the candidate VM 12 and the performance characteristics of the candidate host 14 would be combined to project utilization at the candidate host 14 with such candidate VM 12 deployed thereto.

With regard to the aforementioned virtualization overhead, it is to be further noted that since such overhead is so variable and depends on the workload type of the candidate VM 12, a fixed set of benchmark workloads may be defined in one embodiment of the present invention, one for each type of workload. Such workload types and corresponding benchmarks may include but are not limited to: database server, web server, and terminal server. Each workload type has a specific characterization that allows estimating processor, memory, storage, and network overhead and the like associated with the workload type. In general, more storage-intensive and network-intensive workloads incur more processor overhead due to the cost of virtualizing such resources.

Note that the estimate of virtualization overhead may be refined further. In particular, a processor cost may be associated with a single byte of network and disk 10 transferred between the candidate VM 12 and candidate host 14. If the model data received from the data collector 20 includes disk and network 10 workload, then the evaluator 18 may apply the processor cost for a single byte to such workload data to obtain the total processor overhead. In cases where the processor cost is obtained from a processor which is different than the processor under evaluation, the cost may be rescaled in similar fashion as described at step 401. Such resealing reduces the effort required to model virtualization overhead across a variety of processor configurations.”

The output of the evaluator 18 for each candidate host 14 as was set forth above is a rating that characterizes how well the candidate host 14 can accommodate the candidate VM 12, taking into consideration the resources required by the candidate VM 12 and the overhead required to virtualize the candidate VM 12 at the candidate host 14. In one embodiment of the present invention, such rating is calculated by the evaluator 18 in the following manner.

First, if any of the aforementioned hard requirements is not met such that the candidate host 14 does not have enough of a required resource available, the rating is 0. Moreover, if usage of any resource by the candidate VM 12 at the candidate host 14 causes the candidate host 14 to exceed a threshold set for the use of such resource, the rating is 0 (step 407). As will be set forth in more detail below, each resource at the candidate host 14 has a predetermined threshold of utilization beyond which usage is not recommended. Thus, such threshold in effect defines a reserve of the resource that is to be available to the candidate host 14 to handle higher than expected usage situations. If the rating is set to 0 because the candidate VM 12 causes the candidate host 14 to violate a hard requirement or a threshold, the process stops here. Otherwise, the process continues by calculating a value for the rating (step 409).

In one embodiment of the present invention, a sub-rating is calculated for each of several resources at the candidate host 14 (step 411). Such resources may be any resources without departing from the spirit and scope of the present invention, such as for example, processor utilization, memory utilization, storage utilization, network utilization, and the like.

The sub-rating for each resource is calculated based on a threshold set for the resource, a percent utilization calculated for the resource based on the data gathered, and a weight assigned to the resource, as follows:

Sub-Rating=(Threshold−Percent Utilization)×Weight

The threshold and weight may be selected by an administrator or the like based on any appropriate factors without departing from the spirit and scope of the present invention. The threshold, which is the threshold set forth above, may be expressed as a percentage and corresponds to the aforementioned reserve defined for the resource. Such reserve may be somewhat arbitrarily defined, but in general should be set to provide a reasonable cushion of extra capacity under the circumstances. As an example, if the resource is storage at the candidate host 14, the reserve may be defined as 20 percent of the storage capacity at the candidate host 14, in which case the threshold is 80 percent. Similarly, a reserve of 15 percent would set the threshold as 85 percent, for example. The weight acts to give more emphasis or less emphasis to the resource as compared to other resources when computing the overall rating. Thus, if all resources are considered to be of equal importance, such resources may all be given an even weight, say for example 5. Correspondingly, if one resource is considered to be twice as important as another, the one resource may be given a weight twice that of the another, say for example 6 and 3, respectively.

Critically, the percent utilization for the resource is calculated based on the corresponding data collected by the data collector 20 and/or the data interface 22, as the case may be, and after such data may have been scaled and/or adjusted for overhead as at steps 401 and 403, again as the case may be. Calculating such percent utilization as performed by the evaluator 18 may be performed in any appropriate manner without departing from the spirit and scope of the present invention. Generally, the percent utilization as calculated for any particular resource of the candidate host 14 represents how much of the resource as a percentage is utilized by the candidate host 14 while the candidate VM 12 is deployed thereon, and while the candidate host 14 is performing all other functions that were performed prior to the candidate VM 12 being deployed. Thus, and as an example, if the candidate host 14 prior to the candidate VM 12 was utilizing 20 percent of available network capacity, and if the candidate host 14 after deployment of the candidate VM 12 is projected to utilize 45 percent of such available network capacity (i.e., an additional 25 percent attribute to the candidate VM 12), then the percent utilization of network resources for the candidate host 14 is the 45 percent value.

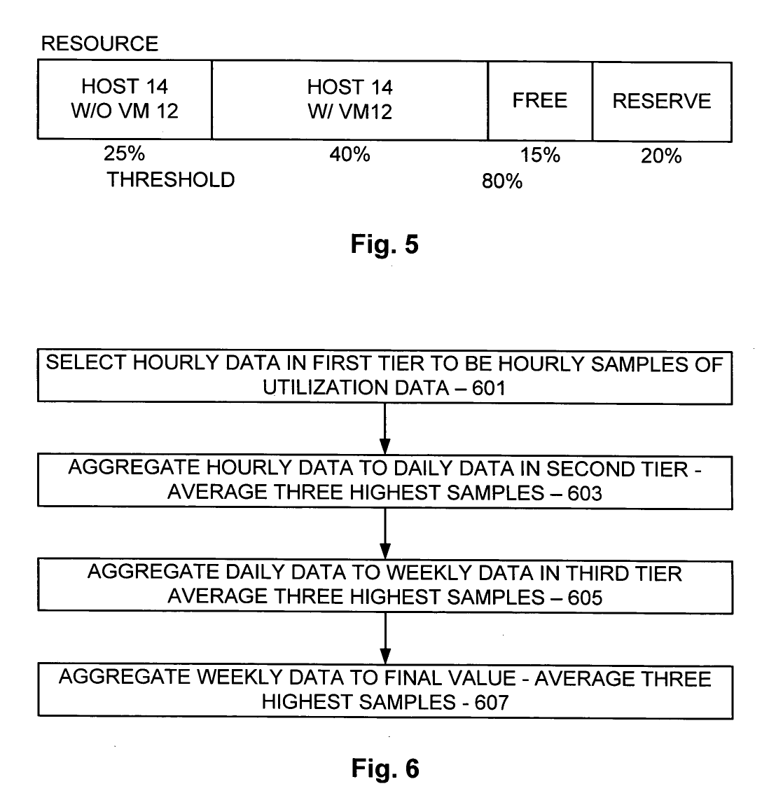

Graphically, percent utilization is represented in FIG. 5. In particular, and as shown, for some particular resource, the candidate host prior to the candidate VM 12 being deployed thereon has a pre-existing host utilization which is shown to be 25 percent, which represents other VMs 12 already deployed to such candidate host 14 as well as all other host operations. After deploying the candidate VM 12, and as shown, an additional utilization by the candidate VM 12 has been determined to be 40 percent, resulting in a total percent utilization of 65 percent. For such resource, a reserve of 20 percent has been set, as shown, with the result being that the threshold is 80 percent (100-20), and that after deploying the candidate VM 12 15 percent of the resource remains free (80-65). Thus, the sub-rating for such resource would be the 80 percent threshold minus the 65 percent total utilization, which is the 15 percent remaining free, multiplied by whatever weight has been set for the resource. In sum, then, the percent utilization of any resource corresponds most closely to the percent of the resource remaining free after the candidate VM 12 is deployed to the candidate host 14 having such resource.

At any rate, once the sub-rating is calculated for each considered resource of the candidate host 14, such sub-ratings are combined to result in the rating for the candidate host 14 (step 413) as follows:

Rating=Sum of Sub-Ratings/Sum of Weights of Sub-Ratings/Normalizing Value

Note that an additional value such as 0.5 may be added to the computation for the rating so that the rating is never less than such additional value. Such rating may also be rounded to the nearest 0.5, with a result being a number between 0 and a maximum value such as 5. As may be appreciated, the normalizing value is selected to constrict the range of the rating between the 0 and maximum values. For example if Sum of Sub-Ratings/Sum of Weights of Sub-Ratings has a maximum value of and the maximum rating is to be 5, the normalizing value would be 20, which is 100/5.

Of course, the rating for each candidate host 14 and the sub-ratings thereof may also be calculated in any other appropriate manner without departing from the spirit and scope of the present invention, presuming of course that the rating represents a reasonable representation of how well the candidate host 14 can accommodate the candidate VM 12 as deployed thereon, and considering all other VMs 12 already deployed to the candidate host 14 and other operations already performed by the candidate host 14. For example, although the rating here in effect emphasizes how much free resources the candidate host 14 will have after deploying the candidate VM 12 thereon, such rating may instead emphasize how much of such resources are used at the candidate host 14.

After the evaluator 18 has calculated a rating for each candidate host 14 for the candidate VM 12, the evaluator may present the ratings to an administrator or the like (step 415), after which the administrator may select from among the rated candidate hosts 14 (step 417). Note here that an administrator likely will select from among the candidate hosts 14 based on one of two deployment strategies—load balancing and resource utilization. In load balancing, the administrator is attempting to deploy the candidate VM 12 on the candidate host 14 with the most resources after such deployment (i.e., free resources), such that ultimately all hosts 14 deploying VMs 12 do so with roughly the same load in a balanced manner. In contrast, in resource utilization, the administrator is attempting to maximize use of each host 14, and thus would wish to deploy the candidate VM 12 to the candidate host 14 with the least resources (i.e., free resources) after such deployment.

Thus, load balancing attempts to leave all hosts 14 equally utilized after deployment, while resource utilization attempts to use up all available resources on one host 14 before moving on to start using a next host 14. As should be appreciated, then, inasmuch as the rating calculated above emphasizes free resources of a candidate host 14, an administrator performing load balancing would likely select the highest rated candidate host 14 for deploying the candidate VM 12 on, which by definition would have the most free resources after such deployment, relatively speaking. In contrast, an administrator performing resource utilization would likely select the lowest non-zero rated candidate host 14 for deploying the candidate VM 12 on, which by definition would have the least free resources after such deployment, relatively speaking.

Once a candidate host 14 has been selected, a reservation of resources may be made at the selected host 14, perhaps by way of a reservation VM 12 that is created and deployed to the selected host 14 (step 419). As may be appreciated, the reservation VM 12 is a ‘shell’ VM 12 without any substantive functionality or content. Such a reservation VM 12 describes the hardware configuration and resource requirements of the candidate VM 12 but omits the memory, data, and storage of the candidate VM 12. As may be appreciated, then, the reservation VM 12 provides an important verification that deployment of the candidate VM 12 is actually possible, especially inasmuch as certain deployment requirements may be known only to the underlying virtualization software and not to the evaluator 18, and deployment requirements may be different between different versions, releases, or different vendors' virtualization systems. In addition, a typical VM 12 may be relatively large, perhaps on the order of several gigabytes or more, and copying such a VM 12 to a host 14, particularly over a slow network 16, could take hours if not more. Thus, the reservation VM 12 is deployed much more quickly and as such acts to reserve host resources for the candidate VM 12 during the time that the candidate VM 12 is in fact being deployed to the selected host 14 (step 421). Note that the reservation of resources as at step 419 may also be achieved by debiting resource usage from the selected host 14 so that further deployments take into account what the deployment of the candidate VM 12 will use in terms of resources.

While the present invention has heretofore been set forth in terms of individual candidate hosts 14, such invention may also be practiced with regard to host groups or the like in a similar manner. As may be appreciated, a host group is a collection of hosts 14, any one of which may accommodate a particular candidate VM 12 if in fact deployed to such host group. Note, though, that resources for a host group may be characterized in a slightly different manner, such as for example based on an average representative of the host group, or based on a collective representation of the host group, or based on the least-provisioned host 14 of the group, or the like.

Also, although the present invention thus far has been described in terms of a candidate VM 12 to be deployed to a host 14, such invention may also be practiced with regard to a candidate VM 12 already deployed to one host 14 but being migrated to a candidate host 14. As may be appreciated, in such case the same evaluation procedure occurs, although some data regarding the candidate VM 12 may be obtained from slightly different sources, and deploying the candidate VM 12 is achieved by migrating the candidate VM 12 from the one host 14 to the selected host 14.

Similarly, while the present invention has heretofore been set forth in terms of individual candidate VMs 12, such invention may also be practiced with regard to a candidate plurality of VMs 12 to be deployed to a candidate host 14, as well as to a candidate host group. A many-to-one deployment involves an evaluation of hypothetical utilization of a candidate host 14 based on the addition of many VMs 12 instead of just one. As should be appreciated, then, resources for the candidate plurality of VMs 12 are represented collectively.

Notably, a many-to-many deployment is more complex. The less computationally intensive way of performing many-to-many deployment is simply to pick an arbitrary ordering of VMs 12 and deploy based on such ordering. However, globally optimal deployment is not achieved inasmuch as a different ordering of the VMs 12 may have resulted in a better overall deployment. A heuristic can be applied to improve the ordering—for instance, the ordering may be based on largest VM 12 to smallest VM 12 as selected based on a weighted aggregation of utilization of various resources. Of course, the fully optimal solution would be to try all possible orderings of VMs 12, although such a solution would likely be prohibitively computationally expensive as well as largely unnecessary inasmuch as the aforementioned heuristic likely produces results that are acceptable.

As was set forth above, the process of determining a rating to characterize deployment of a candidate VM 12 to a candidate host 14 may be employed not only with regard to an already-virtualized VM 12 but also with regard to a physical machine 10 that is a candidate for virtualization. As such, a single candidate VM 12 was evaluated by the evaluator 18 against one or more candidate hosts 14. Note, though, that the evaluator 18 may also evaluate a plurality of candidate VMs 12 against a particular candidate host 14, against a representative of available candidate hosts 14, against a plurality of candidate hosts 14, or the like. In the first two cases, the evaluator 18 would in effect be employed to determine which of the plurality of candidate VMs 12 is best suited to be deployed to a candidate host 14, while in the third case the evaluator 18 would in effect be employed to determine which of the plurality of candidate VMs 12 is best suited to be deployed to which of the candidate hosts 14. Particularly with regard to the first two cases, the evaluator 18 may thus be employed to select from among a plurality of candidate physical machines 10 as represented by corresponding VMs 12 to be virtualized and deployed to a candidate host 14.

### Data of Candidate VM 12, Candidate Host 14 for Evaluator 18

As was alluded to above, depending on whether the candidate VM 12 has already been virtualized from a physical machine 10 or has not as yet been virtualized, the data for the candidate VM 12 that is presented to and employed by the evaluator 18 may derive from differing sources. Note that a candidate VM 12 may be wholly new and not based on any physical machine 10, in which case an administrator or the like may define data for such candidate VM 12, based on expected resources required including processor, memory, network, and storage resources and the like. That said, data for a candidate VM 12 as derived from a physical machine 10 and data for a candidate host 14 may be derived from configuration information and performance data acquired from the physical machine 10 and candidate host 14, respectively, so as to more accurately represent such candidate VM 12 and candidate host 14 to the evaluator 18.

With regard to available performance data in particular for either a VM 12 or host 14, such data may be collected as samples or the like and aggregated in any appropriate manner by way of the data collector 20 and data interface 22 or the like without departing from the spirit and scope, presuming that such aggregation in particular produces a reasonable representation of utilization. In particular, and understanding that resource utilization is generally relatively lower but at busy times relatively higher, average utilization is not an especially good representation of such utilization. Instead, in one embodiment of the present invention, utilization is represented as an average of relatively higher utilization. Accordingly, aggregating sampled data to produce such average higher utilization may be performed over a number of tiers of time. In particular, at each tier, a number of highest values of sampled data are averaged.

For example, and turning now to FIG. 6, it may be the case that a particular utilization data is organized into three tiers, first, second, and third respectively representing hourly, daily, and weekly data, where:
the hourly data in the first tier is selected to be hourly samples of the utilization data (step 601),
the daily data in the second tier is an aggregation of the hourly data in the first tier, specifically the average of the three highest samples of such hourly data (step 603),
the weekly data in the third tier is an aggregation of the daily data in the second tier, specifically the average of the three highest samples of such daily data (step 605), and
a final value of the data to be employed by the evaluator 18 is an aggregation of the weekly data in the third tier, specifically the average of the three highest samples of such weekly data (step 607).

Of course, any number of tiers and any other method of aggregation from tier to tier to produce a final value may also be employed without departing from the spirit and scope of the present invention.

### CONCLUSION

The programming necessary to effectuate the processes performed in connection with the present invention is relatively straight-forward and should be apparent to the relevant programming public. Accordingly, such programming is not attached hereto. Any particular programming, then, may be employed to effectuate the present invention without departing from the spirit and scope thereof.

In the foregoing description, it can be seen that the present invention comprises a new and useful system and method that allows an administrator or the like to deploy the physical machines 10 or the like as VMs 12 on hosts 14. Such system and method efficiently matches a defined workload to a set of compatible physical resources to service the workload, thus facilitating compatible, efficient deployment taking into account resource requirements including networking, storage, processor power, memory, and the like. It should be understood, therefore, that this invention is not limited to the particular embodiments disclosed, but it is intended to cover modifications within the spirit and scope of the present invention as defined by the appended claims.

1. A method with regard to a candidate virtual machine (VM) and a candidate host computing device (host) upon which the candidate VM is potentially to be deployed, the method for assisting in determining whether to deploy the candidate VM to the candidate host taking into consideration resources available from the candidate host and resources required by the candidate VM, the method comprising:
calculating a sub-rating for each of several resources available from the candidate host, the sub-rating for the resource corresponding to an amount of the resource that is free after the candidate VM is deployed to the candidate host;
calculating a rating from the calculated sub-ratings to characterize how well the candidate host can accommodate the candidate VM;
presenting the rating for the candidate host to a selector, the selector for determining whether to deploy the candidate VM to the candidate host based on the rating thereof;
receiving a selection of the candidate host for deployment of the candidate VM thereon;
reserving the resources of the selected host as required by the candidate VM until the candidate VM is deployed to the selected host; and
deploying the candidate VM to the selected host.

2. The method of claim 1 wherein the selector selects the candidate host for deployment of the candidate VM thereon if the candidate host has a relatively high rating and the selector is attempting to perform load balancing of multiple VMs across multiple hosts, whereby the relatively high rating corresponds to the candidate host having a relatively high amount of resources remaining after deployment of the candidate VM thereon, and wherein the selector selects the candidate host for deployment of the candidate VM thereon if the candidate host has a relatively low, non-zero rating and the selector is attempting to perform resource utilization of multiple VMs on the candidate host, whereby the relatively low rating corresponds to the candidate host having a relatively low amount of resources remaining after deployment of the candidate VM thereon.

3. The method of claim 1 comprising calculating the sub-rating for each resource based on a threshold set for the resource, a utilization calculated for the resource based on data gathered, and a weight assigned to the resource, as follows:
Sub-Rating=(Threshold−Utilization)×Weight
wherein the threshold corresponds to a reserve defined for the resource at the candidate host to provide a cushion of capacity for the resource, wherein the weight corresponding to each resource provides a relative emphasis for the resource as compared to other resources, and wherein the utilization for the resource represents how much of the resource is utilized by the candidate host while the candidate VM and any other VMs are deployed thereon.

4. The method of claim 3 wherein the utilization includes pre-existing host utilization prior to deploying the candidate VM on the candidate host and host utilization from the candidate VM after being deployed to the candidate host, and wherein the threshold is an amount of the resource other than the reserve.

5. The method of claim 3 comprising calculating the rating from the sub-ratings and respective weights as follows:
Rating=Sum of Sub-Ratings/Sum of Weights of Sub-Ratings/Normalizing Value
wherein the normalizing value is selected to constrict the range of the rating between 0 and a maximum value.

6. The method of claim 1 wherein the resources include processor utilization, memory utilization, storage utilization, and network utilization.

7. The method of claim 1 wherein the resources include processor utilization and further comprising resealing processor utilization of the candidate VM to an equivalent processor utilization of the candidate host.

8. The method of claim 1 further comprising for at least one resource accounting for virtualization overhead with regard to such resource, whereby the virtualization overhead represents an additional utilization of the resource associated with virtualizing the candidate VM on the candidate host.

9. The method of claim 1 further comprising simulating running of the candidate VM on the candidate host by way of at least simulating placing a dummy VM on the candidate host with utilization parameters corresponding to the candidate VM as deployed and operating on the candidate host to determine if the candidate host acceptably accommodates such dummy VM, thereby confirming that the candidate host can indeed accommodate the candidate VM, at least as represented by the dummy VM.

10. The method of claim 1 comprising setting the rating for the candidate host to zero if with regard to any particular resource the candidate host does not have enough of the resource available.

11. The method of claim 10 comprising setting the rating for the candidate host to zero if usage of the particular resource by the candidate VM at the candidate host causes the candidate host to exceed a threshold set for the use of such resource.

12. The method of claim 1 with regard to the candidate VM and a plurality of candidate host computing devices (hosts) any one of which the candidate VM is potentially to be deployed, the method for assisting in determining which candidate host to deploy the candidate VM to, taking into consideration resources available from each candidate host and resources required by the candidate VM, the method comprising, for each candidate host:
calculating a sub-rating for each of several resources available from the candidate host, the sub-rating for the resource corresponding to an amount of the resource that is free after the candidate VM is deployed to the candidate host; and
calculating a rating from the calculated sub-ratings to characterize how well the candidate host can accommodate the candidate VM;
the method further comprising presenting the rating for each candidate host to a selector, the selector for selecting one of the candidate hosts for deployment of the candidate VM thereon based on the rating thereof.

13. The method of claim 1 with regard to a candidate virtual machine (VM) and a candidate host group upon which the candidate VM is potentially to be deployed, the host group being a collection of hosts, any one of which may accommodate the candidate VM if in fact deployed to such host group.

14. The method of claim 1 with regard to a plurality of candidate VMs and the candidate host, any one of the plurality of candidate VMs potentially being deployed to the candidate host, the method for assisting in determining which candidate VM to deploy to the candidate host, taking into consideration resources available from the candidate host and resources required by each candidate VM, the method comprising, for each candidate VM:
calculating a sub-rating for each of several resources available from the candidate host, the sub-rating for the resource corresponding to an amount of the resource that is free after the candidate VM is deployed to the candidate host; and
calculating a rating from the calculated sub-ratings to characterize how well the candidate host can accommodate the candidate VM;
the method further comprising presenting the rating for each candidate VM to a selector, the selector for selecting one of the candidate VMs for deployment to the candidate host based on the rating thereof.

15. The method of claim 1 with regard to a candidate physical machine to be potentially virtualized to the candidate VM and the candidate host upon which the candidate VM is potentially to be deployed, the method for assisting in determining whether to virtualize the candidate physical machine to the candidate VM and deploy the candidate VM to the candidate host taking into consideration resources available from the candidate host and resources required by the candidate VM.

16. The method of claim 1 comprising calculating the sub-rating for any particular resource based on utilization data gathered with regard to the particular resource, the utilization data representing how much of the resource is utilized by the candidate host while the candidate VM and any other VMs are deployed thereon, and including sampled data aggregated to emphasize relatively higher utilization by:
selecting data in a first tier to be hourly samples of the utilization data;
selecting data in a second tier to be daily data aggregated from the hourly data of the first tier by averaging three highest samples of such hourly data;
selecting data in a third tier to be weekly data aggregated from the daily data of the second tier by averaging three highest samples of such daily data; and
calculating a final value as aggregated from the weekly data of the third tier by averaging three highest samples of such weekly data.

17. The method of claim 1 wherein reserving the resources of the selected host comprises deploying a reservation VM on the selected host, the reservation VM being a VM without substantive functionality and content but holding the resources of the selected host as required by the candidate VM until the candidate VM is deployed to the selected host.

18. The method of claim 1 wherein the candidate VM is deployed to another host, and wherein deploying the candidate VM comprises migrating the candidate VM from the another host to the selected host.

19. A method with regard to a candidate physical machine and a candidate host computing device (host) upon which the candidate physical machine is potentially to be deployed, the method for assisting in determining whether to deploy the candidate physical machine to the candidate host taking into consideration resources available from the candidate host and resources required by the candidate physical machine, the method comprising:
calculating a sub-rating for each of several resources available from the candidate host, the sub-rating for the resource corresponding to an amount of the resource that is free after the candidate physical machine is deployed to the candidate host;
calculating a rating from the calculated sub-ratings to characterize how well the candidate host can accommodate the candidate physical machine;
presenting the rating for the candidate host to a selector, the selector for determining whether to deploy the candidate physical machine to the candidate host based on the rating thereof;
receiving a selection of the candidate host for deployment of the candidate VM thereon;
reserving the resources of the selected host as required by the candidate VM until the candidate physical machine is deployed to the selected host; and
deploying the candidate physical machine as a virtualized version thereof to the selected host.

20. The method of claim 19 with regard to a plurality of candidate physical machines and the candidate host, any one of the plurality of candidate physical machines potentially being deployed to the candidate host, the method for assisting in determining which candidate physical machine to deploy to the candidate host, taking into consideration resources available from the candidate host and resources required by each candidate physical machine, the method comprising, for each candidate physical machine:
calculating a sub-rating for each of several resources available from the candidate host, the sub-rating for the resource corresponding to an amount of the resource that is free after the candidate physical machine is deployed to the candidate host; and
calculating a rating from the calculated sub-ratings to characterize how well the candidate host can accommodate the candidate physical machine;
the method further comprising presenting the rating for each candidate physical machine to a selector, the selector for selecting one of the candidate physical machines for deployment to the candidate host based on the rating thereof.
